(19) United States
(12) Patent Application Publication
(10) Pub. No.: US 2018/0007839 A1
(43) Pub. Date: Jan. 11, 2018

(54) INFORMATIONAL TAGS FOR CONTAINERS AND METHODS OF ASSEMBLY

(71) Applicant: BALL HORTICULTURAL COMPANY, West Chicago, IL (US)

(72) Inventor: Stephen F. Wedemeyer, St. Charles, IL (US)

(21) Appl. No.: 15/202,311

(22) Filed: Jul. 5, 2016

(51) Int. Cl. A01G 9/00; B65D 25/20; G09F 3/02; G09F 3/04

(52) U.S. Cl. CPC A01G 9/006; G09F 3/04; B65D 25/205; G09F 3/02; G09F 2003/0272

(57) ABSTRACT

Disclosed herein is an informational tag for a container such as a garden or plant pot. The informational tag may include a body having an upper end, a lower end, and a display area for receiving printed information. The informational tag may also include a pair of downwardly extending tabs arranged on opposite sides of the upper end of the body and each being configured for insertion into the container. Additionally, the informational tag may include an upwardly extending tab arranged between the pair of downwardly extending tabs and configured to engage a rim of the container to inhibit upward movement of the informational tag relative to the container. Further disclosed is an assembly including a container with an informational tag attached thereto, and a method of assembly.

### FIELD OF DISCLOSURE

The present disclosure generally relates to informational tags and, more particularly, to informational tags which can be attached to an open top container, such as a plant or garden pot, for displaying information relevant to the contents of the container.

### BACKGROUND

Plants, such as bedding and pot plants, are commonly sold to consumers in containers filled with potting mix. Information relevant to the plant's price and type, as well as marketing graphics or text and/or instructions for the plant's care, are oftentimes printed on a stake inserted into the soil by the seller or grower and/or printed directly on the container itself.

The use of such stakes can obstruct the consumer's view of the plant and potentially block a path for watering the plant. Furthermore, the stake usually is inserted into the soil at a relatively shallow depth so that it does not interfere with the plant's growth. Consequently, the stake is prone to separate from the soil during shipping and/or handling.

Printing information directly on the container can have the disadvantage of rendering the container useful for selling only a single type of plant. Furthermore, the seller of the plant may be unable to make changes to the printed information because the seller may not own the necessary equipment to print directly on the container. Thus, the seller's ability to re-use or re-purpose the container may be limited. Furthermore, printing information on the sidewall of a container, which typically involves printing on a curved surface, can be time-consuming and/or expensive.

Various efforts have been made to address the drawbacks associated with soil stakes and pre-printed containers. Informational tags have been proposed which can be attached to the container or the plant itself. However, known tags typically require the container to be modified so that it can interface with the tag. For example, it may be necessary to create a slit in the container so that an attachment portion of the tag can be inserted therethrough. Other known tags require a fastener such as a staple or ring to connect the tag to the container or plant, which in the latter case, may cause damage to the plant. Furthermore, known tags oftentimes extend in the upward direction from the rim of the container. As a result, the tag oftentimes will interfere with the watering path for the plant, similar to the stake described above.

The present disclosure sets forth informational tags and methods embodying advantageous alternatives to existing informational tags and methods, and that may address one or more of the challenges or needs described herein.

### SUMMARY

One aspect of the present disclosure provides an informational tag for a container. The informational tag may include a body having an upper end, a lower end, and a display area for receiving printed information. The informational tag also may include a first downwardly extending tab and a second downwardly extending tab arranged on opposite sides of the upper end of the body and each being configured for insertion into the container. Additionally, the informational tag may include an upwardly extending tab arranged between the first and second downwardly extending tabs and configured to engage a rim of the container to inhibit upward movement of the informational tag relative to the container.

Another aspect of the present disclosure provides an assembly including a container and an informational tag. The container may include a bottom wall and a sidewall. The sidewall may extend upwardly from the bottom wall and terminate at a rim. The informational tag may hang over the rim of the container. The informational tag may include a body having a display area with printed information. At least a portion of the display area may be positioned below the rim of the container. The informational tag may additionally include an upwardly extending tab engaging an underside of the rim of the container to inhibit upward movement of the informational tag relative to the container.

Yet another aspect of the present disclosure provides a method of assembly including: (a) providing a container including a bottom wall and a sidewall, the sidewall extending upwardly from the bottom wall and terminating at a rim; (b) providing an informational tag including a body having a display area with printed information, a first downwardly extending tab and a second downwardly extending tab arranged on opposite sides of the body, and an upwardly extending tab arranged between the first and second downwardly extending tabs; (c) arranging the body of the informational tag outside of the container; (d) inserting the first and second downwardly extending tabs of the informational tag into the container; and (e) arranging the upwardly extending tab of the informational tag to engage an underside of the rim of the container.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicative of the presence or absence of particular elements in any of the exemplary embodiments, except as may be explicitly delineated in the corresponding written description. Also, none of the drawings is necessarily to scale.

FIG. 1 is a front perspective view of one embodiment of an assembly according to principles of the present disclosure.

FIG. 2 is a rear perspective view of the assembly depicted in FIG. 1.

FIG. 3 is a front plan view of the assembly illustrated in FIG. 1.

FIG. 4A is a cross-sectional view along line Z-Z of FIG. 3.

FIG. 4B is a cross-sectional view along line Z-Z of FIG. 3 prior to the informational tag engaging an underside of the rim of the container.

FIG. 5 is a front plan view of one embodiment of an informational tag according to principles of the present disclosure.

FIG. 6 is a front plan view of another embodiment of an informational tag according to principles of the present disclosure.

FIG. 7 is a front plan view of yet another embodiment of an informational tag according to principles of the present disclosure.

### DETAILED DESCRIPTION OF THE DRAWINGS

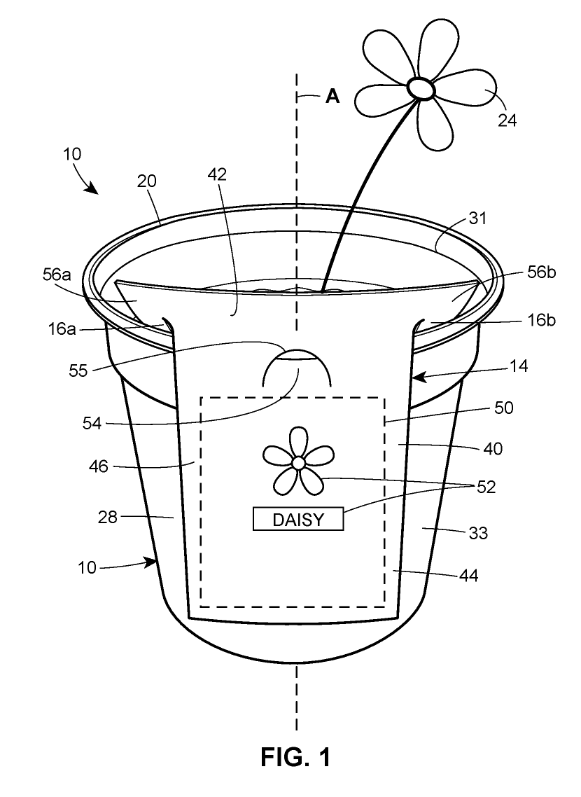

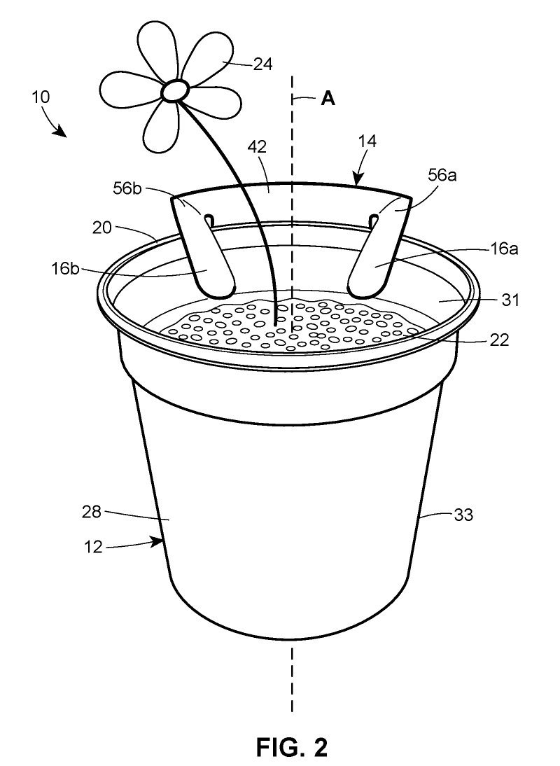

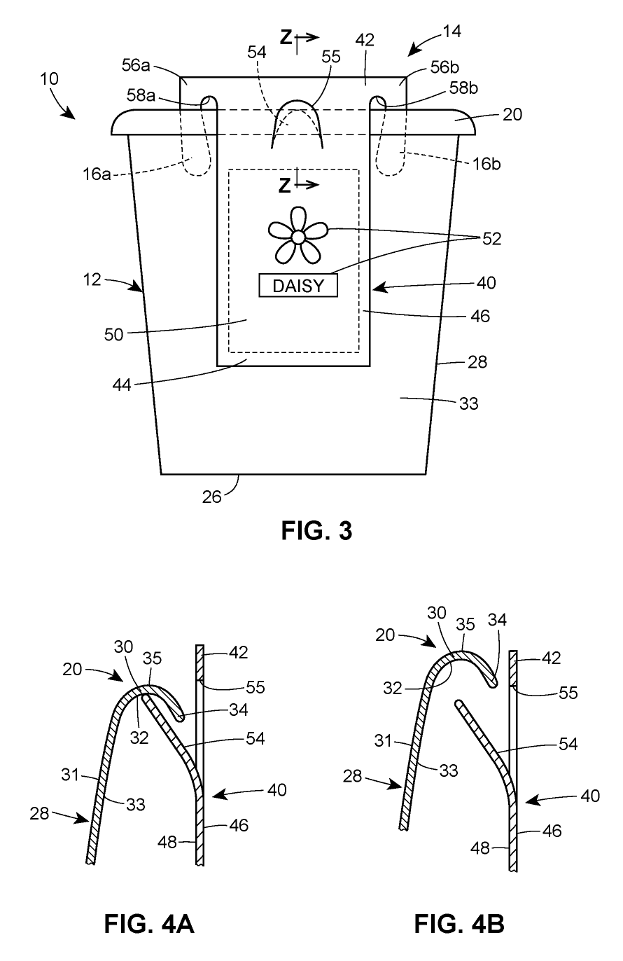

FIGS. 1-3 illustrate one embodiment of an assembly 10 including a container 12 and an informational tag 14 in accordance with principles of the present disclosure. In general, the informational tag 14 is configured so that it can be attached to the container 12 without obstructing lateral access to a plant growing from the container 12. This is accomplished by hanging the informational tag 14 over the side of the container 12 with a pair of downwardly extending tabs or prongs 16a and 16b. Furthermore, to inhibit inadvertent upward movement of the informational tag 14 relative to the container 12, the informational tag 14 may include an upwardly extending tab or prong 18 that engages an underside of a rim 20 of the container 12. Accordingly, the informational tag 14 can be securely attached to the container 12 with most or a majority of the informational tag 14 arranged below the rim 20 of the container 12.

Each of the foregoing components of the assembly 10, and methods of constructing the assembly 10, will now be described in more detail.

Referring to FIGS. 1-3, the container 12 is a garden or plant pot filled with soil 22 for growing a plant 24. The container 12 may include a bottom wall 26 and a sidewall 28 connected thereto. The sidewall 28 may extend upwardly from the bottom wall 26 and terminate at its upper end to form the rim 20 of the container 12. The rim 20 may define an open top for receiving the soil 22 and the plant 24. The sidewall 28 may have an inner surface 31 defining the hollow interior of the container 12 and an outer surface 33 facing outwardly. In the illustrated embodiment, the sidewall 28 has a substantially frustoconical shape which tapers inwardly from the rim 20 toward the bottom wall 16. This shape may facilitate the nesting of multiple containers 12 when stacked on top of each other. In alternative embodiments, the container 12 may include substantially vertical sidewalls. In still further alternative embodiments, the container 12 may take the form of a tray having multiple depressions, each being configured to receive an individual plant. Furthermore, holes (not illustrated) may be formed in the bottom wall 26 to allow water to drain from the container 12.

The container 12 may be constructed of any suitably rigid material including, but not limited to, an injection molded thermoplastic (e.g., high density polyethylene), a biodegradable plastic, a recycled plastic, clay, or any combination of these materials.

Referring to FIG. 4A, the rim 20 of the container 12 may include a peripheral shoulder 30 which extends radially outwardly from the upper end of the sidewall 28. In the illustrated embodiment, the peripheral shoulder 30 is curved. In other embodiments, the peripheral shoulder 30 may be substantially planar and perpendicular to a longitudinal axis A of the container 12 and/or parallel to the bottom wall 26. Furthermore, the peripheral shoulder 30 may include a downwardly facing surface 32 which defines an underside of the rim 20, and an upwardly facing surface 35. Additionally, as shown in FIG. 1, the rim 20 may include a downwardly extending lip 34 disposed at the outer edge of the peripheral shoulder 30. The downwardly extending lip 34 may be angled or curved relative to the peripheral shoulder 30 so that the downwardly extending lip 34 is not perpendicular to the peripheral shoulder 30. Generally, though, the downwardly extending lip 34 may be parallel to the longitudinal axis A of the container 12.

The rim 20 of the illustrated embodiment is circular. However, other embodiments of the rim 20 may have a shape that is square, rectangular, semi-circular, polygonal, or any other suitable shape.

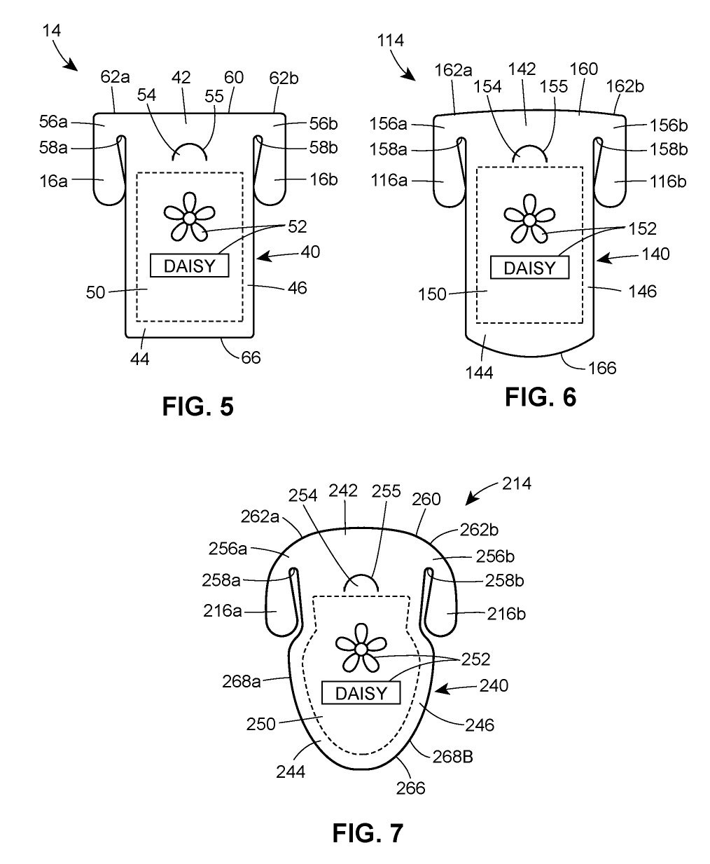

Turning to FIG. 5, one embodiment of the informational tag 14 will now be described. The informational tag 14 may include a central body 40 having an upper end 42, a lower end 44, a front surface 46, and a rear surface 48 (see FIG. 4A). The front surface 46 may include a display area 50 on which is provided printed information 52 relevant to the contents of the container 12. Examples of the printed information 52 include, but are not limited to, the species or genus of the plant 24, the price of the plant 24, marketing graphics, logos, or text, instructions related to the care of the plant 24, and/or any combination thereof. The printed information 52 may be printed directly on the front surface 46 of the body 40 and/or printed on a decal which is adhered to the front surface 46 of the body 40. Although the display area 50 shown in FIG. 5 is limited to a portion of the front surface 40, in other embodiments, the display area 50 may encompass the entire front surface 40, including the front surface of the upwardly extending tab 54. Furthermore, in some embodiments, printed information may also be included on the rear surface 48 of the informational tag 14.

The body 40 may have any suitable shape and dimensions. In the illustrated embodiment, the body 40 is rectangular, and may have a width with a range of approximately (e.g., ±10%) 2.0-4.0 inches and a length within a range of approximately (e.g., ±10%) 3.0-5.0 inches. In some embodiments, the width of the body 40 may be less than or equal to a circumference of the container 12 (e.g., the circumference of the rim 20), and the length of the body 40 may less than or equal to a vertical distance between the rim 20 of the container 12 and the bottom wall 26 of the container 12. In an embodiment where the width of the body 40 is equal to a circumference of the rim 20 of the container 12, the informational tag 14 may wrap around the entire container 12, in which case the informational tag 14 may be made of a relatively flexible material.

Still referring to FIG. 5, the first and second downwardly extending tabs 16a and 16b may be arranged on opposite lateral sides of the upper end 42 of the body 40. In general, when inserted into the interior of the container 12, the first and second downwardly extending tabs 16a and 16b may be configured to prevent or inhibit lateral or horizontal movement (i.e., movement that is perpendicular to the longitudinal axis A) of the informational tag 14 away from the container 12 by engaging the inner surface 31 of the sidewall 28. A first shoulder 56a may extend outwardly in a first horizontal direction from a first lateral side of the body 40; and a second shoulder 56b may extend outwardly in a second horizontal from a second lateral side of the body 40. The first shoulder 56a may connect the first downwardly extending tab 16a to the first lateral side of the body 40; whereas the second shoulder 56b may connect the second downwardly extending tab 16b to the second lateral side of the body 40. The first and second downwardly extending tabs 16a and 16b may extend in the downward direction from, respectively, the first and second shoulders 56a and 56b. In this way, the first and second downwardly extending tabs 16a and 16b are like arms which are connected the body 40 by the first and second shoulder 56a and 56b. Furthermore, as seen in FIG. 5, a gap may exist between the body 40 and each of the first and second downwardly extending tabs 16a and 16b.

Each of the downwardly extending tabs 16a and 16b may have a width that gradually increases traveling in the downward direction away from its respective shoulder 56a or 56b, such that each of the downwardly extending tabs 16a and 16b has a teardrop-like shape, as shown in FIG. 5. This shape may facilitate bending of the downwardly extending tabs 16a and 16b, while maximizing the surface area of the downwardly extending tabs 16a and 16b in contact with the inner surface 31 of the sidewall 28 of the container 30. Other shapes for the downwardly extending tabs 16a and 16b are also possible, including a rectangular, semi-circular, or even a triangular shape.

FIG. 5 illustrates that the informational tag 14 may further include an upwardly extending tab 54. The upwardly extending tab 54 may extend in the opposite direction as the downwardly extending tabs 16a and 16b. Furthermore, as shown in FIG. 5, the upwardly extending tab 54 may be located vertically between the upper and lower ends 42 and 44 of the body 40 and horizontally between the first and second downwardly extending tabs 16a and 16b. Also, as illustrated in FIG. 5, the upwardly extending tab 54 may be offset downwardly from (i.e., positioned below) each of the shoulders 56a and 56b. The upwardly extending tab 54 may not extend beyond the upper end 42 of the body 40.

The upwardly extending tab 54 may be defined by a slit 55 which extends through the body 40. The slit 55 may have a non-linear shape which, as illustrated in FIG. 5, may take the form of a semi-circle. In alternative embodiments, the slit 55 may be V-shaped, U-shaped, or any other shape allowing the upwardly extending tab 54 to be bent away from the body 40. In still further alternative embodiments, the upwardly extending tab 54 may not be defined by a slit in the body 40; rather the upwardly extending tab 54 may be an element which is separate from but connected to the body 40.

With continued reference to FIG. 5, each of the shoulders 56a and 56b may have a respective downwardly facing surface 58a or 58b which spans the distance between one of the downwardly extending tabs 16a or 16b and the body 40. In use, the downwardly facing surfaces 58a and 58b may define first and second stops which abut the upwardly facing surface 35 of the rim 20 of the container 20 to prevent or inhibit further insertion of the downwardly extending tabs 16a and 16b into the interior of the container 20. When a user pushes downwardly on the informational tag 14, the downwardly extending tabs 16a and 16b may elastically deform to such an extent that the downwardly facing surfaces 58a and 58b come into contact with the upwardly facing surface 35 of the rim 20. When the user ceases pushing down on the informational tag 14, the downwardly extending tabs 16a and 16b may regain some of the original shape, due to their elasticity. As a result, the downwardly extending tabs 16a and 16b may be configured to provide an upwardly directed biasing force that pushes the body 40 of the informational tag 14 slightly upwards. This upward movement of the body 40 may cause an upper end of the upwardly extending tab 54 to engage the downwardly facing surface 32 of the peripheral shoulder 30 of the rim 20, as seen in FIG. 4A. Accordingly, upwardly extending tab 54 may define a stop which prevents or inhibits upward vertical movement of the informational tag 14 relative to the container 12 in the vertical direction (i.e., parallel to the longitudinal axis A). Furthermore, because the upper end of the upwardly extending tab 54 may be positioned inwardly of the lip 34 of the rim 20 (see FIG. 4A), the upwardly extending tab 54 also function to prevent or inhibit lateral or horizontal movement of the informational tag 14 away from the container 12.

In total, the informational tag 14 may have three separate stops or lock points defined respectively by the downwardly facing surface 58a of the shoulder 56a, the downwardly facing surface 58b of the shoulder 56b, and the upper end of the upwardly extending tab 54. Alternative embodiments of the informational tag 14 may have lesser or more stops or lock points. For example, the informational tag 14 may have two or more upwardly extending tabs laterally spaced from each other.

As mentioned above, the upwardly extending tab 54 may be offset downwardly from the first and second shoulders 56a and 56b. Stated another way, the upwardly extending tab 54 may be positioned vertically below the first and second shoulders 56a and 56b, such that the upwardly extending tab 54 is closer to the lower end 44 of the body 40 than the first and second shoulders 56a and 56b. Therefore, when the user initially inserts the downwardly extending tabs 16a and 16b into the container 12 and holds the downwardly facing surfaces 58a and 58b against the upwardly facing surface 35 of the rim 20, the upper end of the upwardly extending tab 54 may be positioned lower than the lip 34 of the rim 20, as shown in FIG. 4B. Accordingly, while holding the shoulders 56a and 58b down against the rim 20 of the container 12, the user can slip the upwardly extending tab 54 behind the lip 34. Then, when the user releases the informational tag 14, the elasticity of the first and second upwardly extending tabs 16a and 16b will cause them to push off of the container 12 and exert an upward biasing force on the body 40, which in turn causes the upwardly extending tab 54 to engage the underside of the rim 20, as depicted in FIG. 4A. In this way, the informational tag 14 can be securely attached to the rim 20 of the container 20. Removal of the informational tag 14 may be possible by bending one or more of the first and second downwardly extending tabs 16a or 16b or the upwardly extending tab 54 such that the upwardly extending tab 54 is slipped back out from beneath the lip 34.

The informational tag 14 may be made of any elastic or semi-elastic material that is sufficiently rigid to retain its shape while being flexible enough to bend and partially or fully regain its original shape. The elastic limit of the material used for the informational tag 14 may be such that a person can fold the informational tag 14 to create a permanent or semi-permanent bend (e.g., bending the upwardly extending tab 54 away from the body 40). Suitable materials for the informational tag 14 include, but are not limited to, plastic, paper, and laminated paper. The entire informational tag 14 may be made of single, unitary piece of material such that the downwardly extending tabs 16a and 16b, the body 40, the shoulders 56a and 56b, and the upwardly extending tab 54 are integrally formed. In some embodiments, the downwardly extending tabs 16a and 16b, the shoulders 56a and 56b, and the upwardly extending tab 54 may be formed by cutting away excess material from the body 40.

A method of assembling the informational tag 14 and the container 12 to arrive at the assembly 10 will now be described. Initially, the user may obtain the informational tag 14 in a configuration as shown in FIG. 5. In this configuration, the downwardly extending tabs 16a and 16b and the upwardly extending tab 54 may all lie in a common imaginary plane defined by the body 40. Here, each of the downwardly extending tabs 16a and 16b and the upwardly extending tab 54 may be said to occupy a first position relative to the body 40. Next, the user may bend each of the downwardly extending tabs 16a and 16b and the upwardly extending tab 54 away from the body 40. This may require the user to rotate each of the downwardly extending tabs 16a and 16 in a first rotational direction (e.g., a clockwise direction) and to rotate the upwardly extending tab 54 in a second opposite rotational direction (e.g., a counter-clockwise direction). Rotating the downwardly extending tabs 16a and 16b and the upwardly extending tab 54 may result in a permanent or semi-permanent bend between each of the tabs and the body 40. Once bent, each of the downwardly extending tabs 16a and 16b and the upwardly extending tab 54 may occupy a second position relative to the body 40. Next, the user may position the body 40 of the informational tag 14 adjacent to the sidewall 28 of the container 12, and insert the downwardly extending tabs 16a and 16b in the downward vertical direction into the interior of the container 12 such that downwardly extending tabs 16a and 16b slide against the inner surface 31 of the sidewall 28 and possibly further rotate slightly in the first rotational direction.

The user may continue to advance the informational tag 14 in the downward direction until the downwardly facing surfaces 58a and 58b of the shoulders 56a and 56b abut against the upwardly facing surface 35 of the rim 20 of the container 12. While holding the downwardly facing surfaces 58a and 58b of the shoulders 56a and 56b against the upwardly facing surface 35 of the rim 20, the user may push the body 40 of the informational tag 14 in the horizontal direction toward the container 12 so that the upwardly extending tab 54 is arranged directly below the rim 20, as shown in FIG. 4B. Subsequently, the user may cease pushing down on the informational tag 14, thereby allowing the first and second upwardly extending tabs 16a and 16b to elastically regain some of their original shape. This may cause the first and second upwardly extending tabs 16a and 16b to push off of the container 12 and exert an upward biasing force on the body 40, which in turn causes the upwardly extending tab 54 to engage the underside of the rim 20, as depicted in FIG. 4A. As a result, the informational tag 14 will be hung over the rim 20 of the container 12, as shown in FIGS. 1-3, with the downwardly extending tabs 16a and 16b inhibiting the informational tag 14 from being pulled away from the container 12 in the horizontal direction and with the upwardly extending tab 54 inhibiting the informational tag 14 from being moved in the upward vertical direction relative to the container 12.

While the present embodiment of the method of assembly involves individually bending the downwardly extending tabs 16a and 16b prior to placing the informational tag 14 on the rim 20 of the container 12, in alternative embodiments, the downwardly extending tabs 16a and 16b may not be bent until they are slid in the downward direction over the inner surface 31 of the sidewall 28 of the container 12. Also, the upwardly extending tab 54 may not be bent inwardly by the user until the downwardly extending tabs 16a and 16b have been inserted into the container 12.

Various advantages result from this assembly of the informational tag 14. Because most or a majority of the informational tag 14 is arranged below the rim 20 of the container 12, the informational tag 14 does may not obstruct a horizontal path for watering the plant 24. Also, the container 12 does not have to be specifically configured to accommodate the informational tag 14. Accordingly, the informational tag 14 can be used with a wide variety of containers 12 of different shapes and sizes. Furthermore, providing the printed information on the informational tag 14 as opposed to the container 12 can help reduce printing costs.

Turning to FIG. 6, an informational tag 114 is illustrated in accordance with another embodiment of the present disclosure. The informational tag 114 is similar to the informational tag 14 described above, except for the shape of various exterior surfaces. Elements of the informational tag 114 which are similar to the informational tag 14 are designated by the same reference numeral, incremented by 100. A description of many of these elements is abbreviated or even eliminated in the interest of brevity.

As shown in FIG. 6, the upper end 142 of the body 140 may have an upwardly facing surface 160 which is curved. Furthermore, each of the shoulders 156a and 156b may possess a respective upwardly facing surface 162a or 162b which is curved. The curves of the upwardly facing surface 160 and the upwardly facing surfaces 162 and 162b may blend into each other so that the upper end 142 of the body 140 and the shoulders 156a and 156b define a single continuous curved surface. As illustrated in FIG. 6, this continuous curved surface may have a convex curvature. Other curvatures are also possible including a concave curvature.

Still referring to FIG. 6, the lower end 144 of the body 140 may have a downwardly facing surface 166. The downwardly facing surface 166 may also have a convex curvature as shown, or any other curvature including a concave curvature. By comparison, the downwardly facing surface 66 and the upwardly facing surface 60 of the informational tag 14 may be linear, as shown in FIG. 5.

Looking to FIG. 7, an informational tag 214 is illustrated in accordance with yet another embodiment of the present disclosure. The informational tag 214 is similar to the informational tag 14 described above, except for the shape of various exterior surfaces. Elements of the informational tag 214 which are similar to the informational tag 14 are designated by the same reference numeral, incremented by 200. A description of many of these elements is abbreviated or even eliminated in the interest of brevity.

As shown in FIG. 7, the upper end 242 of the body 240 may have an upwardly facing surface 260 which is curved. Furthermore, each of the shoulders 256a and 256b may possess a respective upwardly facing surface 262b or 262b which is curved. Each of the downwardly extending tabs 216a and 216b may possess an outwardly facing surface 264a and 264b which is curved. The curves of the upwardly facing surface 260, the upwardly facing surfaces 262a and 262b, and the outwardly facing surfaces 264a and 264b may blend into each other so that the upper end 242 of the body 240, the shoulders 256a and 256b, and the downwardly facing tabs 216a and 216b define a single continuous curved surface. As illustrated in FIG. 7, this continuous curved surface may have a convex curvature or any other suitable curvature.

Still referring to FIG. 7, the lower end 244 of the body 240 may have a downwardly facing surface 266 and oppositely disposed lateral surfaces 268a and 268b. The downwardly facing surface 266 and the lateral surfaces 268a and 268b may each be curved such that the downwardly facing surface 266 and the lateral surfaces 268a and 268b define a single continuous curve. As illustrated in FIG. 7, this continuous curved surface may have a convex curvature. Other curvatures are also possible.

It is noted that the curvature of the various exterior surfaces of the informational tags illustrated in FIGS. 6 and 7 is not necessarily limited by the inclusion of the downwardly extending tabs of the upwardly extending tab. In this way, the configuration of the downwardly extending tabs and the upwardly extending tab facilitate a variety of exterior shapes for the informational tag.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. An informational tag for a container, the informational tag comprising:
a body having an upper end, a lower end, and a display area for receiving printed information;
a first downwardly extending tab and a second downwardly extending tab arranged on opposite sides of the upper end of the body and each being configured for insertion into the container; and
an upwardly extending tab arranged between the first and second downwardly extending tabs and configured to engage a rim of the container to inhibit upward movement of the informational tag relative to the container.

2. The informational tag of claim 1, the upwardly extending tab being defined by a non-linear slit extending through body.

3. The informational tag of claim 2, a lower end of each of the first and second downwardly extending tabs terminating above the lower end of the body.

4. The informational tag of claim 3, comprising a first shoulder extending outwardly from a first side of the body and connecting the first downwardly extending tab to the body, and a second shoulder extending outwardly from a second side of the body and connecting the second downwardly extending tab to the body.

5. The informational tag of claim 4, the upper end of the body and the first and second shoulders defining a continuous curved surface.

6. The informational tag of claim 4, the slit being offset downwardly below the first and second shoulders.

7. The informational tag of claim 1, each tab of the first downwardly extending tab, the second downwardly extending tab, and the upwardly extending tab being movable from a respective first position to a respective second position, wherein the first downwardly extending tab, the second downwardly extending tab, and the upwardly extending tab lie in a common imaginary plane when each is arranged in its respective first position.

8. The informational tag of claim 1, the body, the first downwardly extending tab, the second downwardly extending tab, and the upwardly extending tab being integrally formed of a single material.

9. The informational tag of claim 1, wherein the body is planar.

10. The informational tag of claim 1, comprising plant-related information printed on the display area of the body.

11. An assembly comprising:
a container including a bottom wall and a sidewall, the sidewall extending upwardly from the bottom wall and terminating at a rim; and
an informational tag hung over the rim of the container, the informational tag including
a body having a display area with printed information, at least a portion of the display area being positioned below the rim of the container, and
an upwardly extending tab engaging an underside of the rim of the container to inhibit upward movement of the informational tag relative to the container.

12. The assembly of claim 11, the informational tag including a first downwardly extending tab and a second downwardly extending tab each engaging an inner surface of the sidewall of the container.

13. The assembly of claim 11, the upwardly extending tab being arranged between the first and second downwardly extending tabs.

14. The assembly of claim 13, the upwardly extending tab being defined by a non-linear slit extending through body.

15. The assembly of claim 11, the informational tag including a first shoulder extending outwardly from a first side of the body and connecting the first downwardly extending tab to the body, and a second shoulder extending outwardly from a second side of the body and connecting the second downwardly extending tab to the body.

16. The assembly of claim 15, the slit being offset downwardly from the first and second shoulders.

17. A method of assembly comprising:
providing a container including a bottom wall and a sidewall, the sidewall extending upwardly from the bottom wall and terminating at a rim;
providing an informational tag including a body having a display area with printed information, a first downwardly extending tab and a second downwardly extending tab arranged on opposite sides of the body, and an upwardly extending tab arranged between the first and second downwardly extending tabs;
arranging the body of the informational tag outside of the container;
inserting the first and second downwardly extending tabs of the informational tag into the container; and
arranging the upwardly extending tab of the informational tag to engage an underside of the rim of the container.

18. The method of claim 17, comprising bending the first and second downwardly extending tabs away from the body prior to inserting the first and second downwardly extending tabs into the container.

19. The method of claim 18, comprising bending the upwardly extending tab away from the body prior to arranging the upwardly extending tab to engage the underside of the rim of the container.

20. The method of claim 17, the upwardly extending tab being defined by a non-linear slit extending through body.
